(19) United States
(12) Patent Application Publication
(10) Pub. No.: US 2010/0291395 A1
(43) Pub. Date: Nov. 18, 2010

(54) Reflective building paper

(76) Inventor: Dave J. Sharkey, JR., Brentwood, CA (US)

Correspondence Address: LITMAN LAW OFFICES, LTD., PATENT LAW BUILDING, 8955 CENTER STREET, MANASSAS, VA, 20110, US

(21) Appl. No.: 12/453,555

(22) Filed: May 14, 2009

(51) Int. Cl. B32B 29/00; B32B 15/12

(52) U.S. Cl. 428/464; 428/537.5

(57) ABSTRACT

The reflective building paper is building paper, such as roofing paper, tar paper, wallpaper or the like, having a reflective inner surface, for reflecting unwanted radiant heat energy from a building structure. The reflective building paper includes a first building paper layer having opposed first and second faces. An adhesive layer is preferably formed on the first face of the building paper layer. A thermally reflective layer is further provided, having opposed first and second faces, with the second face thereof being secured to the first face of the building paper layer by the adhesive layer. The first face of the reflective layer is adapted for mounting on a building support surface, such as a roof or a wall, and the second face of the building paper layer faces outwardly, forming a conventional surface of tar paper, wallpaper or the like.

### BACKGROUND OF THE INVENTION

1. Field of the Invention

The present invention relates to building insulation and construction materials, and particularly to reflective building paper that can be used for reflecting unwanted radiant heat energy from a building structure.

2. Description of the Related Art

Tar paper is a common type of roofing paper. Tar paper is a heavy-duty paper used in construction. Tar paper is formed by impregnating paper with tar, producing a waterproof material useful for roof construction. Roofing felt, a common type of tar paper, is a glass fiber or polyester fleece impregnated with bituminous material (tar and asphaltic bitumen, for example). Roofing felt is typically produced in roll form. In some cases, mineral material (e.g., sand) is applied on one side thereof to help prevent the material from sticking together while in roll form, and to provide protection from atmospheric conditions.

Tar paper is used, among other things, for waterproofing roofs to prevent ingress of moisture. It is used as underlayment for asphalt, wood, other shingles, or even gravel, since tar paper itself is not particularly wind or sun resistant. Tar paper itself does not provide much protection for the interior of the building to which it is applied from external radiant heat energy, such as direct sunlight. Even in combination with shingles or gravel, the roofing materials typically do not provide an adequat thermal protective barrier, and other forms of thermal insulation must be used.

Many new pitched roofs use a thermoplastic polyolefin membrane for increased protection against leaks. These membranes (which are usually made up of advanced fabrics) have advantages over traditional roofing felt, in that they are more durable and less prone to puncture and tear. They are also lighter and stronger. There are further breathable variations, which allow water vapor to pass through the felt and when used in conjunction with proper ventilation, they help minimize condensation in loft spaces.

Wallpaper is another common building paper. Wallpaper is used to cover and decorate the interior walls of homes, offices, and other buildings. Wallpaper is usually sold in rolls and is applied to a wall using wallpaper paste. Wallpapers can come either plain (so that it can be painted), or with patterned graphics. Typical wallpaper provides little to no thermal insulation, and is used solely for decorative purposes.

Thus, reflective building paper solving the aforementioned problems is desired.

### SUMMARY OF THE INVENTION

The reflective building paper is building paper, such as roofing paper, tar paper, wallpaper or the like, having a reflective inner surface, for reflecting unwanted radiant heat energy from a building structure, and further retaining desired thermal energy within the building structure. The reflective building paper includes a first building paper layer having opposed first and second faces. The building paper layer may be any type of building paper, such as roofing paper, tar paper, roofing felt, wallpaper or the like.

An adhesive layer is preferably formed on the first face of the building paper layer. A thermally reflective layer is further provided, having opposed first and second faces, with the second face thereof being secured to the first face of the building paper layer by the adhesive layer. Any suitable type of adhesive may be utilized. Alternatively, the thermally reflective layer may be secured to the building paper layer by any suitable type of attachment. The first face of the reflective layer is adapted for mounting on a building support surface, such as a roof or a wall, and the second face of the building paper layer faces outwardly, forming a conventional surface of tar paper, wallpaper or the like.

These and other features of the present invention will become readily apparent upon further review of the following specification and drawings.

### BRIEF DESCRIPTION OF THE DRAWINGS

FIG. 1 is a side view in section of a sheet of reflective building paper according to the present invention.

FIG. 2 is a plan view of the reflective building paper of FIG. 1, showing a reflective inner face thereof.

FIG. 3 is a plan view of the reflective building paper of FIG. 1, showing an outer face thereof.

FIG. 4 is an environmental side view of the reflective building paper of FIG. 1.

Similar reference characters denote corresponding features consistently throughout the attached drawings.

### DETAILED DESCRIPTION OF THE PREFERRED EMBODIMENTS

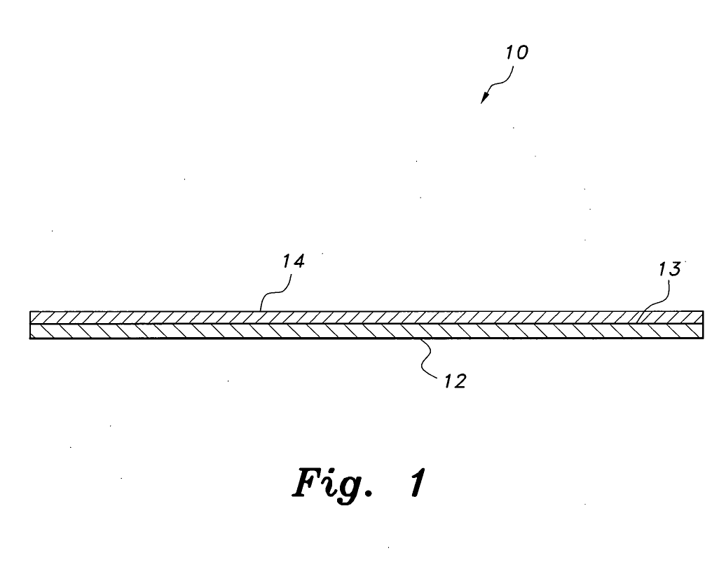

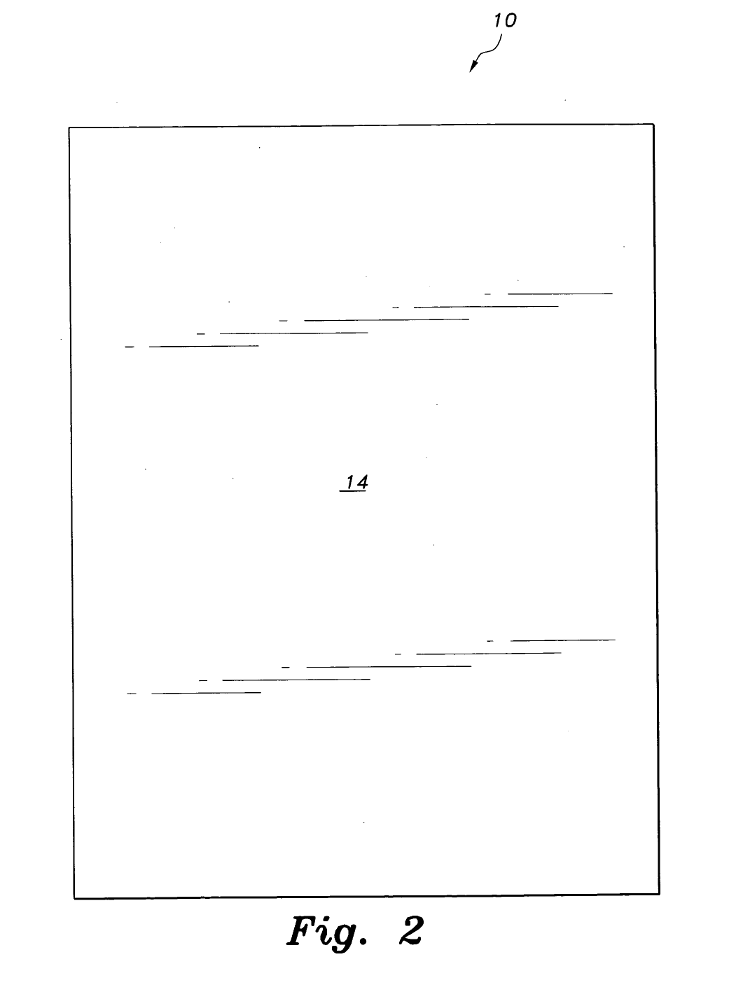

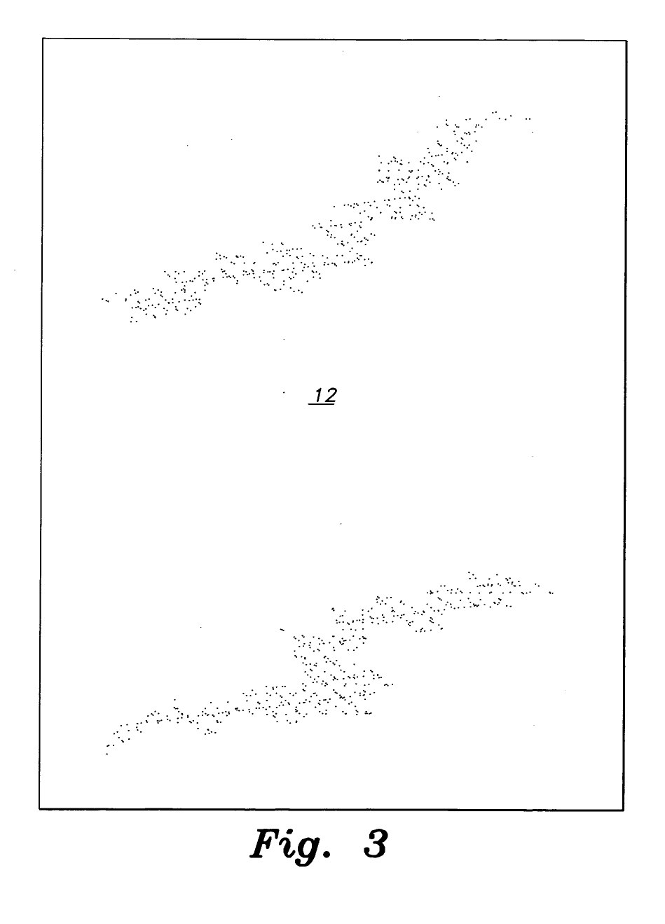

Now referring to FIGS. 1-3, the reflective building paper 10 has a reflective inner surface for reflecting unwanted radiant heat energy away from a building structure and retaining desired thermal energy within the building structure. The reflective building paper 10 includes a first building paper layer 12 having opposed first and second faces. The building paper layer 12 may be any type of building paper, such as roofing paper, tar paper, roofing felt, wallpaper or the like. One such exemplary material is sold under the mark Capital 30 Hybrid Underlayment, manufactured by International Integration, LLC. Such hybrid roofing felt underlayments are desirable, in that they are typically formed from high-performance, spunbond polyester, coated with asphalt, thus making such hybrids approximately half the weight of organic felts, and further making them easier to install. Such hybrids provide ultraviolet protection and are relatively tear-resistant. It should be understood, however, that any desired building paper or roofing material may be used, without departing from the spirit or scope of the invention as claimed.

An adhesive layer 13 is preferably formed on the first face of the building paper layer 12. A thermally reflective layer 14 is further provided, having opposed first and second faces, with the second face thereof being secured to the first face of the building paper layer 12 by the adhesive layer 13. Any suitable type of adhesive may be utilized. Adhesive layer 13 may coat the entire surface of building paper layer 12, or may be applied only in particular spots. Alternatively, the thermally reflective layer 14 may be secured to the building paper layer 12 by any suitable type of attachment.

The thermally reflective layer 14 is formed from any suitable type of thermally reflective material, such as metal foil, reflective insulating material, or a radiant barriers. Radiant barriers are typically formed from aluminum foil or the like. One such radiant barrier is sold under the name Polar-Ply Radiant Barrier, manufactured by the Polar-Ply Corporation of San Dimas, Calif.

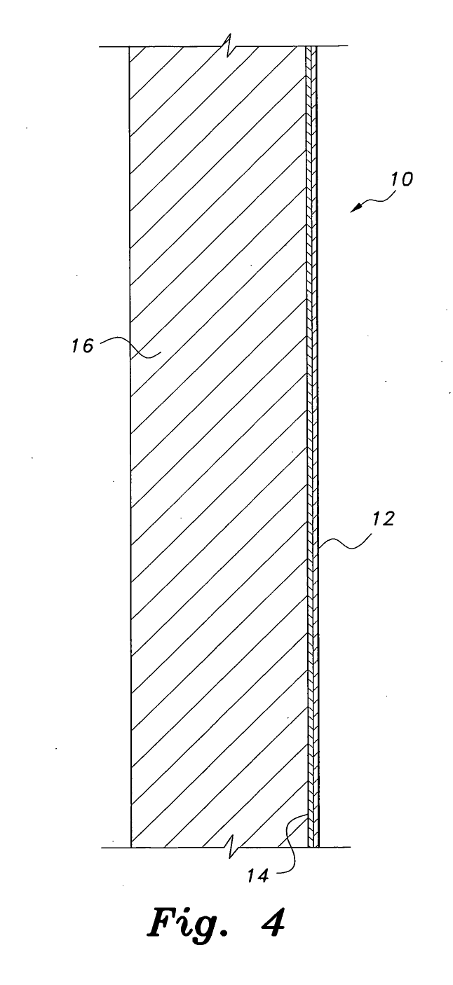

As shown in FIG. 4, the first face of the reflective layer 14 is adapted for mounting on a building support surface 16, such as a roof or a wall, and the second face of the building paper layer 12 faces outwardly, forming a conventional surface of tar paper, wallpaper or the like. Reflective layer 14 may be secured to support surface 16 by any suitable type of attachment. Outer surface materials, such as stucco or the like, may then be applied to the tar paper in a conventional manner.

It is to be understood that the present invention is not limited to the embodiments described above, but encompasses any and all embodiments within the scope of the following claims.

I claim:

1. A reflective building paper, comprising:
a layer of building paper having opposed first and second faces;
an adhesive layer formed on the first face of the layer of building paper; and
a thermally reflective layer having opposed first and second faces, the second face of the reflective layer being adhered to the first face of the layer of building paper by the adhesive layer;
whereby the first face of the reflective layer is adapted for mounting on a building support surface.

2. The reflective building paper as recited in claim 1, wherein said building paper layer comprises roofing paper.

3. The reflective building paper as recited in claim 2, wherein said building paper layer comprises tar paper.

4. The reflective building paper as recited in claim 3, wherein said building paper layer is selected from the group consisting of roofing felt and hybrid roofing felt.

5. The reflective building paper as recited in claim 1, wherein said building paper layer comprises wallpaper.

6. The reflective building paper as recited in claim 1, wherein said thermally reflective layer comprises a radiant barrier.

7. The reflective building paper as recited in claim 6, wherein said thermally reflective layer comprises aluminum foil.

8. A reflective building paper, comprising:
a building paper layer having opposed first and second faces; and
a thermally reflective layer having opposed first and second faces, the second face of the reflective layer being laminated to the first face of the building paper layer;
whereby the first face of the reflective layer is adapted for mounting on a building support surface.

9. The reflective building paper as recited in claim 8, wherein said building paper layer comprises roofing paper.

10. The reflective building paper as recited in claim 9, wherein said building paper layer comprises tar paper.

11. The reflective building paper as recited in claim 10, wherein said building paper layer comprises roofing felt.

12. The reflective building paper as recited in claim 8, wherein said building paper layer comprises wallpaper.

13. The reflective building paper as recited in claim 8, wherein said thermally reflective layer comprises a radiant barrier.

14. The reflective building paper as recited in claim 13, wherein said thermally reflective layer comprises aluminum foil.

15. The reflective building paper as recited in claim 8, further comprising an adhesive layer disposed between the second face of said thermally reflective layer and the first face of said building paper layer.
